(19) United States
(12) Patent Application Publication
(10) Pub. No.: US 2010/0025627 A1
(43) Pub. Date: Feb. 4, 2010

(54) REACTION METHOD, METAL OXIDE NANOPARTICLE OR CARBON CARRYING THE NANOPARTICLE, OBTAINED BY THE METHOD, ELECTRODE CONTAINING THE CARBON, AND ELECTROCHEMICAL DEVICE WITH THE ELECTRODE

(75) Inventors: Katsuhiko Naoi, Tokyo (JP); Nobuhiro Ogihara, Tokyo (JP); Shuichi Ishimoto, Tokyo (JP)

Correspondence Address: YOUNG & THOMPSON, 209 Madison Street, Suite 500, Alexandria, VA, 22314, US

(73) Assignees: K & W LIMITED, KUNITACHI-CITY, TOKYO (JP); NIPPON CHEMI-CON CORPORATION, TOKYO (JP)

(21) Appl. No.: 12/096,770

(22) PCT Filed: Nov. 30, 2006
(86) PCT No.: PCT/JP2006/324027

§ 371 Date: May 22, 2009

(30) Foreign Application Priority Data
Dec. 9, 2005 (JP) 2005-356845

(51) Int. Cl. H01M 4/96; C01G 23/04; C01G 55/00; H01G 9/04

(52) U.S. Cl. 252/182.1; 423/609; 423/592.1; 361/508

(57) ABSTRACT

The present invention aims at: providing an accelerated reaction in a liquid-phase reaction; forming, by way of the reaction, a metal oxide nanoparticle and carbon that carries the metal oxide nanoparticle in a highly dispersed state; and providing an electrode containing the carbon and an electrochemical device using the electrode. In order to solve the above-mentioned problem, shear stress and centrifugal force are applied to the reactant in the rotating reactor so that an accelerated chemical reaction is attained in the course of the reaction. Further, the carbon carrying a metal oxide nanoparticle in a highly dispersed state comprises: a metal oxide nanoparticle produced by the accelerated chemical reaction, wherein shear stress and centrifugal force are applied to a reactant in a rotating reactor in the course of the reaction; and carbon dispersed in the rotating reactor by applying shear stress and centrifugal force. An electrochemical device produced by using the carbon carrying the metal oxide nanoparticle as an electrode has high output and high capacity characteristics.

### TECHNICAL FIELD OF INVENTION

The present invention relates to a chemical reaction method in which production of insoluble product by way of liquid-phase chemical reaction is accelerated, and further relates to a nanoparticle or carbon that carries the nanoparticle, an electrode containing the carbon, and an electrochemical device using the electrode.

### BACKGROUND OF THE INVENTION

Conventionally, reaction methods have been recognized in which insoluble products including metal oxide and metal hydroxide are produced in liquid-phase chemical reactions such as hydrolysis reaction, oxidation reaction, polymerization reaction, condensation reaction. The most typical of such reaction method is the sol-gel method. However, the sol-gel method is so slow in reaction speed due to the reliance of the method on hydrolysis reaction, polycondensation reaction and so on of metallic salt, that no uniform products can be obtained. An example of the known method to solve the problem is the one in which a catalyst is used to accelerate the reaction. Other such examples include a method in which a highly reactive reactant is used (Patent Document 1) and a method in which the agitation process is improved (Patent Document 2).

Still other such examples include a method in which a hydroxide metallic hydrate produced by such a liquid-phase chemical reaction is used as an electric energy-storing element (Patent Document 3).

Patent Document 1. Japanese Laid-open Patent Publication No. H8-239225

Patent Document 2: Japanese Laid-open Patent Publication No. H11-60248

Patent Document 3: Japanese Laid-open Patent Publication No. 2000-36441

However, there remained a problem that such methods could not achieve an accelerated chemical reaction and that hence no uniform products could be obtained. Another remaining problem was that a nanoparticle preferable as an electric energy-storing element could not be produced.

### SUMMARY OF THE INVENTION

It is thus an object of the present invention to provide a method for accelerating a reaction in a liquid-phase chemical reaction to an unprecedented speed. It is another object of the present invention to provide a metal oxide nanoparticle produced in the reaction method, and carbon produced in the reaction method to be used as an electrode material for an electrochemical device, with the carbon carrying the metal oxide nanoparticle in a highly dispersed state; and at providing an electrochemical device using the electrode.

The reaction method according to the present invention is characterized in that a chemical reaction is accelerated by applying shear stress and centrifugal force to a reactant in a rotating reactor in the course of the chemical reaction. In the inventive reaction method, it is supposed that mechanical energies of both shear stress and centrifugal force are applied to a reactant at the same time, and that hence the mechanical energies are converted into chemical energies, resulting in acceleration of chemical reaction to an unprecedented speed.

Further, the reaction produces a thin film containing the reactant in a rotating reactor, and shear stress and centrifugal force are applied to the thin film, whereby great shear stress and centrifugal force are applied to the reactant contained in the thin film, resulting in further acceleration of the chemical reaction.

Acceleration of such a chemical reaction can be achieved by causing, in a reactor, the reactant in the inner tube to pass, by means of the centrifugal force generated from the rotation of the inner tube, through the through-holes to the inside wall of the outer tube so that a thin film containing the reactant is produced on the inside wall of the outer tube, and by applying shear stress and centrifugal force to the thin film, wherein the reactor comprises a pair of outer and inner concentric tubes, the inner tube having through-holes provided on the side thereof and the outer tube having an end plate at the opening thereof.

When the thin film is 5 mm or less in thickness, the effect of the reaction method according to the present invention can be enhanced.

When the centrifugal force to be applied to the reactant inside the inner tube of the reactor is 1500 N (kgms⁻²) or greater, the effect of the reaction method according to the present invention can be enhanced.

Such a chemical reaction according to the present invention can be applied to a hydrolysis reaction or a condensation reaction of metallic salt.

A metal oxide nanoparticle can be formed by the above-described chemical reaction.

Further, the carbon according to the present invention is characterized in that the carbon is one that carries a metal oxide nanoparticle in a highly dispersed state, the carbon comprising: a metal oxide nanoparticle produced by applying shear stress and centrifugal force to a reactant in a rotating reactor in the course of the chemical reaction; and a carbon dispersed by applying shear stress and centrifugal force in a rotating reactor.

The carbon that carries a metal oxide nanoparticle in a highly dispersed state is formed in the following manner: as a metal oxide nanoparticle is produced, the metal oxide nanoparticle and carbon are uniformly dispersed; and upon completion of the reaction, a metal oxide nanoparticle is carried on the surface of the carbon in a highly dispersed state.

The carbon can be prepared by the reaction method according to the present invention: namely, causing the reactant and carbon to react and disperse at the same time where the reactant and carbon are mixed.

This carbon can be used as an electrode material for an electrochemical device. The electrode is nanomized and the specific surface area thereof is remarkably extended, so that the output characteristics of the electrode are enhanced when used as a lithium ion-storing electrode, while the capacity characteristics of the electrode are enhanced when used as a proton-storing electrode.

Hence, use of the electrode enables attainment of an electrochemical device having high output and high capacity characteristics.

As discussed above, in the chemical reaction method according to the present invention, it is supposed that both shear stress and centrifugal force are applied to a reactant at the same time, and that hence such mechanical energies are converted into chemical energies necessary for the reaction, resulting in acceleration of chemical reaction to an unprecedented speed. Application of the method to the hydrolysis and condensation reactions of metallic salt allows for instantaneous progress of the reaction, leading to production of a metal oxide nanoparticle.

Further carbon that carries a metal oxide nanoparticle in a highly dispersed state can be obtained by placing carbon into the reactant in the course of the chemical reaction, and an electrochemical device having high output and high capacity characteristics can be obtained by using the carbon as an electrode.

### BRIEF DESCRIPTION OF THE DRAWINGS

FIG. 1 is an example of a reactor used in the reaction according to the present invention.

FIG. 2 is a TEM image of a Ketjen black that carries a titanium oxide nanoparticle obtained in Working Example 1 in a highly dispersed state.

FIG. 3 is a TEM image of a carbon nanotube that carries a ruthenium oxide nanoparticle obtained in Working Example 3 in a highly dispersed state.

FIG. 4 shows the Charge/Discharge behavior of Working Examples 1 and 2.

FIG. 5 shows the rate characteristics in Working Examples 1 and 2 and Comparative Example.

### DESCRIPTION OF THE PREFERRED EMBODIMENTS

The present invention will now be described in more detail.

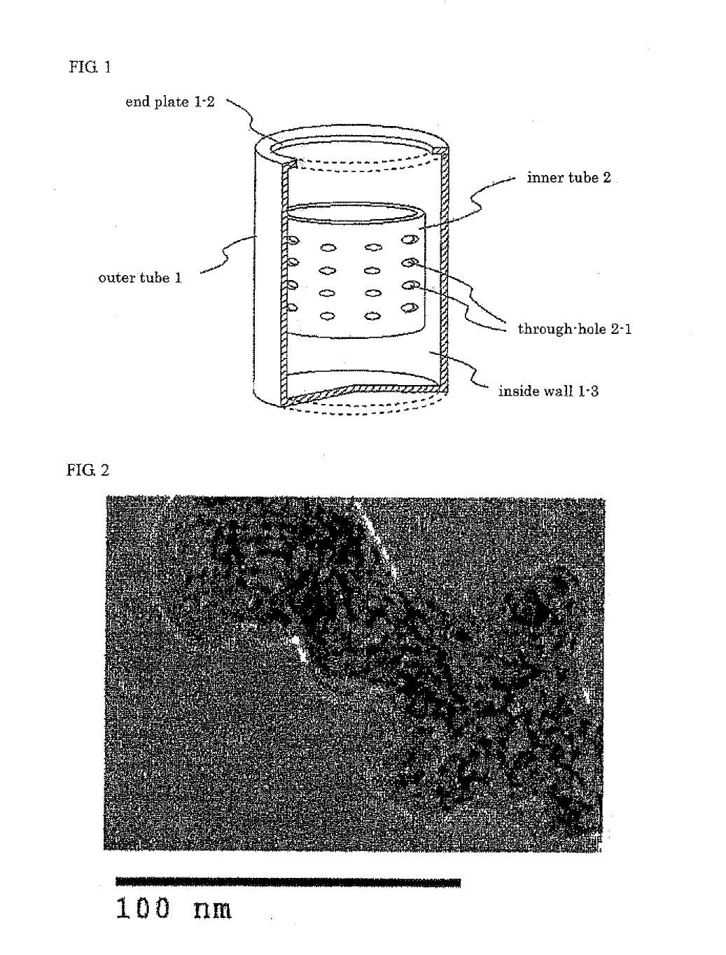

The method for chemical reaction according to the present invention can be carried out using a reactors for example, one as shown in FIG. 1. As depicted in FIG. 1, the reactor comprises an outer tube 1 that has at an opening thereof an end plate 1-2, and an inner tube 2 that has through holes 2-1 and rotates. A reactant is placed inside the inner tube of the reactor, and the inner tube is caused to rotate. The centrifugal force caused by the rotation makes the reactant inside the inner tube pass through the through-holes to the inside wall 1-3 of the outer tube. The reactant collides against the inner wall of the outer tube by means of the centrifugal force caused by the inner tube, so that the reactant takes a thin-film shape and rides up toward the upper portion of the inner wall. In this condition, the reactant receives both the shear stress thereof against the inner wall and the centrifugal force from the inner tube at the same time, causing great mechanical energies to be applied to the thin film-shaped reactant. The mechanical energies are supposed to convert into chemical energies necessary for the reaction, or so-called activation energies, resulting in instantaneous progress of the reaction.

In this reaction, the mechanical energies applied to the thin film-shaped reactant are too great, and thus the thin film should be 5 mm or less in thickness, preferably 2.5 mm or less, more preferably 1.0 mm or less. Meanwhile, the thickness of the thin film can be arranged in accordance with the width of the end plate and the amount of the reaction liquid.

Further, the reaction method according to the present invention is supposed to be achieved by means of the mechanical energies of shear stress and centrifugal force applied to the reactant, with the shear stress and the centrifugal force being generated by the centrifugal force applied to the reactant inside the inner tube. Hence, the centrifugal force to be applied to the reactant inside the inner tube necessary for the present invention is 1500 N (kgms⁻²) or greater, preferably 70000 N (kgms⁻²), more preferably, 270000 N (kgms⁻²) or greater.

The above-described reaction method according to The present invention, in the case of liquid-phase chemical reaction, can be applied to a variety of reactions including hydrolysis reaction, oxidation reaction, polymerization reaction and condensation reaction.

In particular, if the above-described reaction method is applied to the production of metal oxide by way of the hydrolysis and condensation reactions of metallic salt, which production has been conventionally performed in the sol-gel method, then a uniform metal oxide nanoparticle can be formed.

Examples of metal of metal oxide include Li, Al, Si, P, B, Ti, V, Cr, Mn, Fe, Co, Ni, Cu, Zn, Nb, Mo, Ru, Pb, Ag, Cd, In, Sn, Sb, W and Ce. Examples of oxide include M_{X}O_{Z}, A_{X}M_{y}O_{Z}, M_{X}(DO₄)_{y}, A_{X}M_{y}(DO₄)_{Z} (where M is metallic element, A is alkaline metal or lanthanoid element, and D is Be, B, Si, P, Ge and so on) and solid solution thereof.

Each of these metal oxide nanoparticles operates as an active material preferable for an electrode for an electrochemical device. Namely, the nanoparticulation causes the specific surface area of the electrode remarkably extended, whereby the output characteristics and the capacity characteristics thereof are enhanced.

Further, in such a chemical reaction of producing metal oxide by way of the hydrolysis and condensation reactions of metallic salt, addition of carbon in the course of the reaction enables acquisition of carbon that carries a metal oxide nanoparticle in a highly dispersed state. Namely, metallic salt and carbon are placed inside the inner tube of the reactor as shown in FIG. 1, and the inner tube is rotated to mix and disperse the metallic salt and carbon. Besides, while rotating the inner tube, a catalyst such as sodium hydroxide is added so that the hydrolysis and condensation reactions proceed to produce a metal oxide, mixing the metal oxide and the carbon in a dispersion state. Upon completion of the reaction, carbon that carries a metal oxide nanoparticle in a highly dispersed state can be formed.

Examples of carbon used here include carbon black such as Ketjen black and acetylene black, carbon nanotube, carbon nanohorn, amorphous carbon, carbon fiber, natural graphite, artificial graphite, activated carbon and mesoporous carbon, and a composite material thereof.

The carbon that carries the above-described metal oxide nanoparticle in a highly dispersed state can be optionally calcined, kneaded with a binder and formed, so that the carbon can serve as an electrode of an electrochemical device, namely, an electric energy-storing electrode, the electrode showing high output characteristics and high capacity characteristics.

Examples of the electrochemical device to which the electrode can be applied include an electrochemical capacitor and a battery that employ an electrolytic solution containing lithium ion, and an electrochemical capacitor and a battery that employ an aqueous solution. In other words, the electrode according to the present invention is configured for redox reaction of lithium ion and proton. Further, the electrode according to the present invention can operate as either negative or positive electrode depending on the selection of counter electrodes having different metal species and oxidation-reduction potentials. Hence, an electrochemical capacitor and a battery can be comprised by using an electrolytic solution containing lithium ion or an aqueous electrolytic solution, and by using, as a counter electrode, an activated carbon, a carbon that redox-reacts with lithium, a macromolecule that redox-reacts with proton, and a metal oxide that redox-reacts with lithium or proton.

The present invention will now be described in more detail with reference to Working Examples.

### WORKING EXAMPLE 1

40 ml of isopropyl alcohol, 1.25 g of titanium tetrabutoxide and 1 g of Ketjen black (made by Ketjen Black International Co., Ltd., Product Name: Ketjen black EC600JD, Porosity: 78 Vol. %, Primary Particle Size: 40 nm, Average Secondary Particle Size: 337.8 nm) were added into a rotating reactor, and were agitated in the reactor. Then, 1 g of water was placed into the reactor, and the internal tube was rotated at the centrifugal force of 66,000 N (kgms⁻²) for 10 minutes, so that a thin film of the reactant was formed on the internal wall of the outer tube, and that shear stress and centrifugal force were applied to the reactant for accelerated chemical reaction, whereby a Ketjen black that carried an titanium oxide nanoparticle in a highly dispersed state was obtained.

The obtained Ketjen black that carried the titanium oxide nanoparticle in a highly dispersed state was filtered through a filter folder, and was dried at 100° C. for 6 hours, whereby a structure was obtained in which a nanoparticle of titanium oxide was carried on the internal surface of the Ketjen black in a highly dispersed state. FIG. 2 illustrates the TEM image of this structure. It can be seen from FIG. 2 that a titanium oxide nanoparticle of 1 to 10 nm in size was carried on the Ketjen black in a highly dispersed state.

### WORKING EXAMPLE 2

1 g of carbon nanotube (made by JEMCO Inc.) was used instead of the Ketjen black, and ten, a carbon nanotube that carried a titanium oxide nanoparticle in a highly dispersed state was obtained in a manner similar to Working Example 1. The primary particle size of the titanium oxide nanoparticle was 1 to 10 nm.

### WORKING EXAMPLE 3

40 ml of water, 1.965 g of ruthenium chloride and 1 g of carbon nanotube (made by JEMCO Inc.) were used instead of isopropyl alcohol, titanium tetrabutoxide and Ketjen black, and then, a carbon nanotube that carried a ruthenium oxide nanoparticle in a highly dispersed slate was obtained in a manner similar to Working Example 1. FIG. 3 illustrates the TEM image of this structure. It can be seen from FIG. 3 that a ruthenium oxide nanoparticle of 1 to 10 nm in size was carried on the Ketjen black in a highly dispersed state.

### COMPARATIVE EXAMPLE

Taking the conventional sol-gel method, and without taking the inventive chemical reaction, a Ketjen black that cared an titanium oxide particle was obtained in a manner similar to Working Example 1. The primary particle size of the titanium oxide particle was 10 to 50 nm.

The results evidently show that, in Comparative Example, the particle grew to 10 to 50 nm in size at the time of reaction completion, while in Working Examples, the particle grew to 1 to 10 nm in size at the time of reaction completion, and that hence the reaction method according to the present invention could achieve the acceleration of liquid-phase chemical reaction to an unprecedented speed.

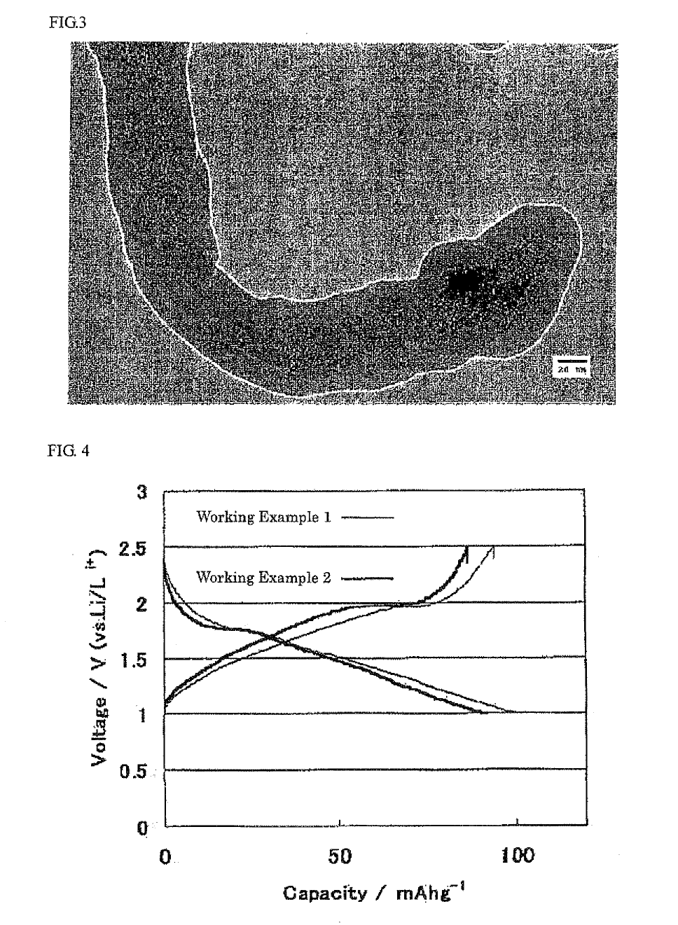

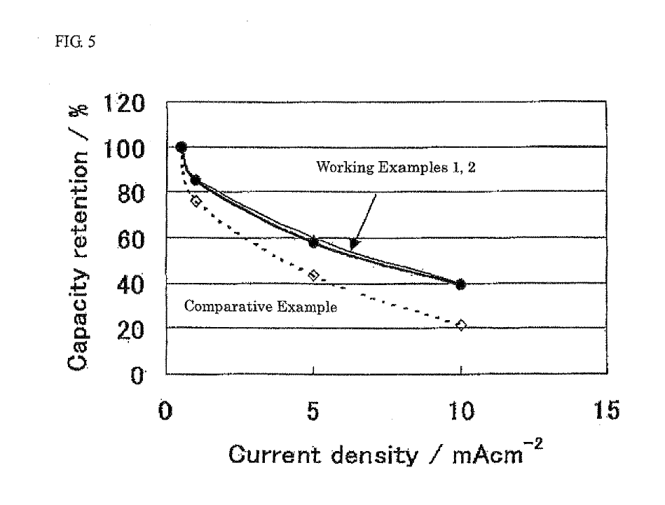

A heat treatment was carried out with respect to the samples obtained in Working Examples 1 and 2 and Comparative Example at 400° C. for 12 hours in the nitrogen atmosphere. The heat-treated samples were mixed with a binder, formed, and then fixed by applying pressure onto an SUS mesh so that the samples were shaped into electrodes. After vacuum drying the electrodes, a cell was fabricated using metallic lithium as the counter electrode, together with 1MLiPF6/EC-DEC (1:1 vol. %) as an electrolytic solution, and then, the Charge/Discharge behavior and the rate characteristics were studied. The results are shown in FIGS. 4 and 5.

According to FIG. 4, the electrodes used in Working Examples 1 and 2 had a plateau in the proximity of 1.75 to 2.0 V. This shows that the electrodes were configured for oxidation reduction of the Ti(III) to Ti(IV) state, and that they could operate as energy-storing oxide combined electrodes for electrochemical devices.

According to FIG. 5, the electrodes used in Working Examples 1 and 2 show a capacity retention rate higher than those used in Comparative Example 1, thus the former are more effective as electrodes for high output electrochemical devices.

What is claimed is:

1. A reaction method for accelerating a chemical reaction, wherein shear stress and centrifugal force are applied to a reactant in a rotating reactor in the course of the chemical reaction.

2. A reaction method for accelerating a chemical reaction and for dispersing a product and carbon, wherein shear stress and centrifugal force are applied to a reactant and carbon in a rotating reactor in the course of the chemical reaction.

3. The reaction method according to claims 1 and 2 for accelerating the chemical reaction, wherein a tin film containing a reactant is produced in a rotating reactor and wherein shear stress and centrifugal force are applied to the thin film.

4. The reaction method according to claim 3,
wherein the reactor comprises a pair of outer and inner concentric tubes, the inner tube having through-holes provided on the side thereof, and the outer tube having an end plate at an opening thereof,
wherein the reactant in the inner tube is caused, by centrifugal force generated from the rotation of the inner tube, to pass through the through-holes to the inside wall of the outer tube so that a thin film containing the reactant is produced on the inside wall of the outer tube, and
wherein shear stress and centrifugal force are applied to the thin film so that the chemical reaction is accelerated.

5. The reaction method according to claims 3 and 4, wherein the thin film is 5 mm or less in thickness.

6. The reaction method according to claims 4 and 5, wherein the centrifugal force to be applied to the reactant inside the inner tube of the reactor is 1500 N (kgms⁻2) or greater.

7. The reaction method according to claims 1 to 6, wherein the chemical reaction is a hydrolysis reaction and/or a condensation reaction of metallic salt.

8. A metal oxide nanoparticle formed in the reaction method according to claims 1 to 7.

9. A carbon that carries a metal oxide nanoparticle in a highly dispersed state, comprising:
a metal oxide nanoparticle produced by applying shear stress and centrifugal force to a reactant in a rotating reactor in the course of the chemical reaction; and
a carbon dispersed by applying shear stress and centrifugal force in a rotating reactor.

10. A carbon that carries the metal oxide nanoparticle in a highly dispersed state according to claim 9 prepared by the reaction method according to claims 2 to 7.

11. An electrode that contains carbon carrying the metal oxide nanoparticle according to claims 9 and 10 in a highly dispersed state.

12. An electrochemical device using the electrode according to claim 11.
